(19) United States
(12) Patent Application Publication
(10) Pub. No.: US 2026/0049591 A1
(43) Pub. Date: Feb. 19, 2026

(54) Architectural Optimization of Wall-to-Roof Interface to Enhance Wind Turbine Efficiency

(71) Applicant: Vincent Loccisano, Wellesley, MA (US)

(72) Inventor: Vincent Loccisano, Wellesley, MA (US)

(21) Appl. No.: 19/305,599

(22) Filed: Aug. 20, 2025

(51) Int. Cl. F03D 1/04; F03D 9/45; F03D 13/20

(52) U.S. Cl. CPC F03D 1/051; F03D 1/046; F03D 9/45; F03D 13/20; F05B 2240/9112

(57) ABSTRACT

An aerodynamic form mounted at the interface between a building's wall and roof having an aerodynamic form that intercepts oncoming wind and directs it over the edge of the roof as laminar flow directed toward a wind turbine mounted on or proximal to the roof. This directed airflow channeled toward the rotors of the one or more wind turbines increases power generation while reducing noise from turbulent flow.

### TECHNICAL FIELD

The present disclosure relates generally to architectural design and construction, specifically focusing on the interface between the wall and roof of a building and an aerodynamic effect designed to enhance efficiency of roof-mounted wind turbines.

### BACKGROUND OF THE INVENTION

While large-scale wind farms in rural or offshore locations are a major source of wind power there is increasing interest in distributed energy generation within urban and suburban environments. One such approach involves the installation of relatively smaller wind turbines on the rooftops of commercial and industrial buildings. This offers the potential to generate power directly at the point of consumption, reducing transmission losses and utilizing existing structures.

The effectiveness of rooftop wind turbine installations faces a significant aerodynamic challenge inherent in the architecture of buildings having flat or nearly flat roofs. Buildings, particularly those with flat or low-slope roofs, typically act as large bluff bodies in the path of oncoming wind. When wind flows against a building's vertical wall and moves upward toward the roofline, it encounters a sharp, rectilinear edge at the parapet or roof perimeter.

This abrupt change in geometry causes the airflow to separate from the building surface, creating a region of highly turbulent, recirculating and low-velocity air ove the forward portion of the roof surface. Wind turbines placed within this turbulent zone are forced to operate in a suboptimal condition. The non-uniform airflow can lead to significantly reduced power output as well as increased mechanical stress and vibration on the turbine blades and components which can shorten the turbine's operational lifespan and can increase maintenance costs.

There remains a need for an apparatus that can condition the airflow over a building's roof edge to mitigate turbulence and provide a more uniform and relatively higher-velocity wind profile to roof-mounted turbines, thereby increasing turbine efficiency, power output and overall viability as a distributed energy solution.

### SUMMARY OF THE INVENTION

The present invention is directed to an apparatus for improving the efficiency of wind turbines mounted on buildings.

Conventional buildings with flat, or nearly flat, roofs having rectilinear edges at the interface of their walls and roof create turbulent airflow when struck by wind. This turbulent flow reduces the velocity and quality of the wind available to power roof-mounted wind turbines, thereby decreasing their operational efficiency.

The invention solves this problem by providing an aerodynamic form mounted at the interface between a building's wall and roof. The form has an outer surface shaped like the leading edge of an airfoil. This structure intercepts oncoming wind and directs it over the edge of the roof as laminar flow through a wind turbine rotor. This directed airflow, channeled toward, and through, the rotors of one or more wind turbines mounted on the roof, increases the amount of electrical power generated by each wind turbine, while reducing noise from turbulent flow.

In various embodiments the aerodynamic form may be installed along multiple edges or the entire perimeter of a building, allowing the system to effectively capture wind from any direction to improve turbine performance regardless of the wind direction relative to the building. In other embodiments an airfoil is placed both below and above at least one turbine supported by neutral aerodynamic structures referred to as fins. In yet other embodiments an airfoil surrounds the rotor of at least one turbine meeting the lower aerodynamic structure at the juncture of the wall and roof of the building.

### BRIEF DESCRIPTION OF DRAWINGS

FIG. 1 is a detail, perspective view of the invention on a building with roof-mounted wind turbines;

FIG. 2 is a detail, perspective view of an iteration of the invention on a building with roof-mounted wind turbines;

FIG. 3 is a detail, perspective view of an additional iteration of the invention on a building with roof-mounted wind turbines.

### DETAILED DESCRIPTION

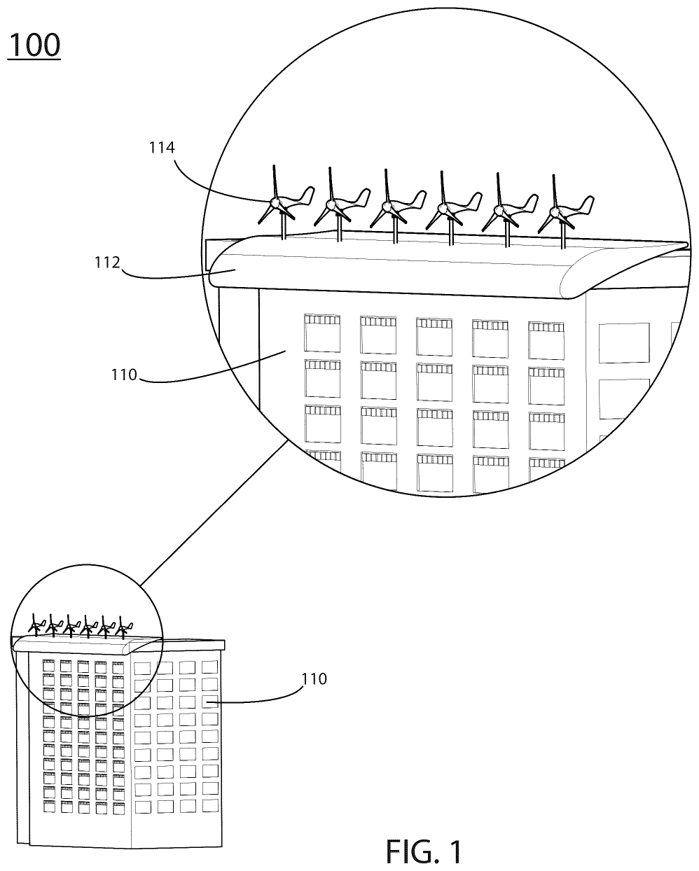

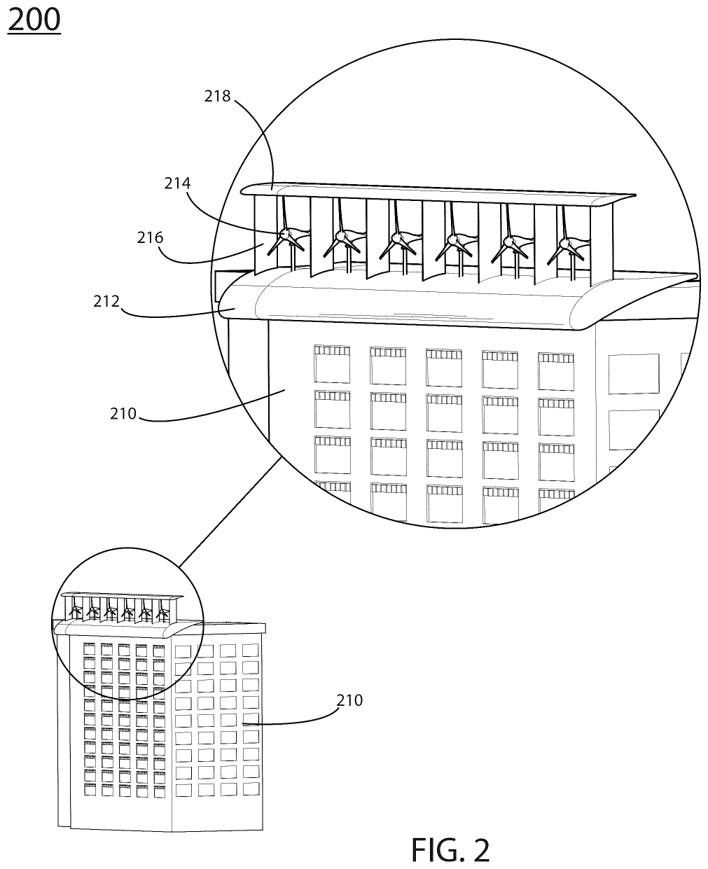

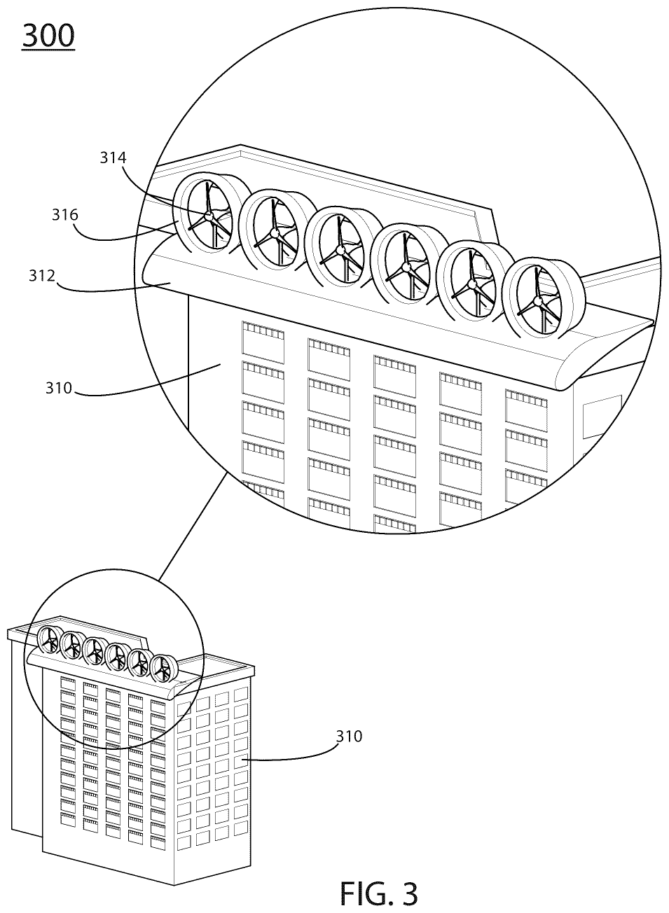

FIG. 1, depicts an embodiment 100 of the invention on a building. An aerodynamic form 112 has an airfoil cross section and is mounted on a building 110 at the interface between the building walls and roof. Wind turbines 114 are mounted on the rooftop of the building in fluid communication with airflow over the top of the aerodynamic form. The angle of attack of the aerodynamic form 112 directs flow over the edge of the building 110 toward the wind turbines 114. Wind that would otherwise become turbulent flow upon meeting a rectilinear edge at the interface of a building wall and rooftop, is directed as laminar flow toward the wind turbines 114. One skilled in the art understands that in some embodiments, the aerodynamic form 112 may be mounted on edges about the perimeter of a building to direct flow from any direction, toward one or more turbines mounted on the roof of the building. In other embodiments, particularly when prevailing winds tend to encounter the building 110 from the same or similar direction during a majority of the time, the embodiment may be mounted on one edge of the building as shown in FIG. 1, FIG. 2 and FIG. 3.

FIG. 2 depicts an iteration of the embodiment 200. A first aerodynamic form 212 has an airfoil cross section and is mounted on a building 210 at the interface between at least one building wall and roof. Wind turbines 214 are mounted on the rooftop of the building in fluid communication with airflow over the top of the aerodynamic form. The angle of attack of the first aerodynamic form 212 directs flow over the edge of the building 210 toward the wind turbines 214. Wind that would otherwise become turbulent flow upon meeting a rectilinear edge at the interface of a building wall and rooftop, is directed as laminar flow toward the wind turbines 214. vertical supports 216 have neutral aerodynamic cross sections and support a second aerodynamic form 218. A neutral cross section is one that has a curved front end similar to the leading edge of an airfoil, without however, a lift surface and pressure surface common to airfoils but with a symmetrical form providing minimal wind resistance with neither lift nor pressure. One skilled in the art can see by end surfaces that show the airfoil cross sections, of the first aerodynamic form 212 and the second aerodynamic form 218, that the lift surface, commonly known as the top surface of an airplane wing of both aerodynamic forms 212/218, face the wind turbines 214. In this manner, greater mass flow is directed to the wind turbines 214 than would otherwise flow through the wind turbines 214 if the wind were to flow past the edge of the building between the wall and roof.

FIG. 3 depicts an iteration of the embodiment 300. An aerodynamic form 312 has an airfoil cross section and is mounted on a building 310 at the interface between at least one building wall and roof. Wind turbines 314 are mounted on the rooftop of the building in fluid communication with airflow over the top of the aerodynamic form. The angle of attack of the aerodynamic form 312 directs flow over the edge of the building 310 toward the wind turbines 314. Ringed airfoils 316 surround the rotor of the wind turbines 314.

One skilled in the art understands that the lift surface, of the ringed airfoils 316 as well as the aerodynamic form 312, face the wind turbines 314. In this manner, increased mass flow is directed to the wind turbines 314.

1. An apparatus for improving the efficiency of a building-mounted wind turbine comprising:
providing a building having at least one wall and a roof, wherein an interface is formed at the juncture of the wall and roof; and
at least one wind turbine mounted on the roof; and
a first aerodynamic form mounted at the interface, the first aerodynamic form having a cross-section of an airfoil configured to intercept an oncoming wind and direct the wind as a substantially laminar flow toward the at least one wind turbine.

2. The apparatus of claim 1 wherein:
the first aerodynamic form is mounted along a plurality of edges of said building's perimeter.

3. The apparatus of claim 1 wherein:
the first aerodynamic form is configured to direct the wind over the edge of the roof and through a rotor of the at least one wind turbine.

4. The apparatus of claim 1 further comprising:
a plurality of vertical supports mounted on said roof, said vertical supports having a neutral aerodynamic cross-section; and
a second aerodynamic form supported by the vertical supports and positioned above the at least one wind turbine, the second aerodynamic form having an airfoil cross-section.

5. The apparatus of claim 4 wherein:
a lift surface of the first aerodynamic form and a lift surface of the second aerodynamic form are oriented to face said at least one wind turbine, thereby channeling an increased mass flow of wind through the at least one wind turbine.

6. The apparatus of claim 1 further comprising:
at least one ringed airfoil, wherein the ringed airfoil surrounds a rotor of the at least one wind turbine, the lift surface of the at least one ringed airfoil oriented to face the rotor of the at least one wind turbine to direct flow therethrough.
